(19) United States
(12) Patent Application Publication
(10) Pub. No.: US 2021/0394031 A1
(43) Pub. Date: Dec. 23, 2021

(54) SET OF GRIP BANDS FOR HANDLES

(71) Applicants: Juan Antonio NUNEZ TRIGUERO, VINYOLS I ELS ARCS (TARRAGONA) (ES); Angel ROBLES ESTEVEZ, MATARO (ES); Cristian RODRIGUEZ ESTEVEZ, MATARO (ES)

(72) Inventor: CRISTIAN RODRIGUEZ ESTEVEZ, MATARO (ES)

(21) Appl. No.: 17/292,760

(22) PCT Filed: Nov. 10, 2019
(86) PCT No.: PCT/ES2019/070766

§ 371 Date: May 11, 2021

(30) Foreign Application Priority Data
Nov. 15, 2018 (ES) 201831764

(51) Int. Cl. A63B 60/14; A63B 49/08

(52) U.S. Cl. CPC A63B 60/14; A63B 2209/10; A63B 49/08

(57) ABSTRACT

A grip assembly comprising a sheet comprising a plurality of grips for handles, said plurality of grips being contained in the sheet itself, such that at least one grip is adapted to be separated from the sheet through at least one weakening line when said sheet receives a force greater than the breaking stress of said weakening line.

### TECHNICAL FIELD

The present invention relates to the field of grips, for example, sports racket grips. These grips are also commonly known as “overgrips” or “grip tapes”. In particular, the present invention relates to a set of grips joined together through weakening lines, wherein each grip can be placed on the handles of tennis, badminton, squash, paddle rackets, etc. as well as any other type of rackets. In addition, the claimed assembly may also be used in other devices such as handlebars for bicycles, motorcycles or any other type of handles, for example, fishing rods.

### BACKGROUND

Currently, it is common to see tennis, squash, badminton, paddle players, etc. before starting a game, cover the handle of their paddle or racket with an overgrip. One of the main uses of overgrips is to provide a greater grip to the user of the racket. In addition, there are overgrips with different thicknesses and padding to prevent players from cutting with edges of the handle, as it can be uncomfortable and annoying. Additionally, there are overgrips that have small holes in order to increase perspiration and facilitate the sweat from the hand to dry faster, and to achieve the desired grip.

In general, overgrips wear out over time, offering less and less grip and sweat absorption characteristics. It is well known that overgrips should be replaced periodically to maintain good maintenance of the racket. Most users replace overgrips by themselves.

However, current overgrips have a very important drawback: their format and/or arrangement (layout). The current overgrips come in an individual format, for example, a single overgrip with a length of approximately one thousand millimetres, usually rolled, that is, arranged in the form of a roll. Generally, this overgrip format has a relatively high cost. Therefore, this format and/or arrangement is directly related to the manufacturing process and strongly influences the cost of the product, since each overgrip is an individual product. Other overgrips have similar technical characteristics, but with a much greater length, in which said length of the overgrip may exceed ten meters. In this case, users should carry scissors or any other cutting tool to trim the overgrip before placing it on the handle of the racket.

It is not uncommon to see inexperienced users cut the overgrip too much, or too little. If a user cuts the overgrip too much, then the overgrip is too long to place it properly on the handle, so the user will have to make an additional cut, that is, a second cut and discard the excess part. On the other hand, if the user cuts too little, then the overgrip is too short to place it properly on the handle, so the user will not be able to place said overgrip on the entire desired length of the handle, and will possibly have to remove it after having begun to place it on the handle, discard the overgrip completely, and cut a new portion of the overgrip.

The length of the overgrip is important because it allows the user to hold the racket with the proper force. If the overgrip is too long, it will move undesirably in the user's hand and so the user will not be able to use the racket (hit the ball) with confidence. If, on the other hand, the length of the overgrip is too short, it will be uncomfortable to hold the racket.

Therefore, if the user wants, for example, four overgrips, then he has to buy four separate overgrips, or alternatively he has to buy an overgrip roll normally of several meters in length and cut it and place it properly on the handle of the sports racket.

### SUMMARY

It is an object of the present invention to provide a device that solves the drawbacks of the state of the art relating to the overgrips in individual mode, meaning overgrips consisting on a single grip tape.

To overcome said drawback of the state of the art, the present invention provides a grip assembly comprising a sheet which, in turn, comprises a plurality of grips for handles, said plurality of grips being contained in the sheet itself, such that at least one grip is adapted to be separated from the sheet through at least one weakening line when said sheet receives a force greater than the breaking stress of said weakening line.

Preferably, the plurality of grips are attached together by at least one weakening line. Preferably, the sheet is substantially flat and is subject to folding (can be folded). More preferably, said folding comprises a folding in the form of a roll. That is, the assembly in the form of a sheet is wrapped in the form of a roll. More preferably, said grip assembly is wound at least two turns on itself. Preferably and according to another example, said folding comprises a folding in the form of an accordion. That is, the grip assembly in the form of a folded sheet in the shape of an eight or a zigzag, in such a way that it has two more parallel folds, made in opposite directions alternately.

Preferably, the cross section of the sheet is substantially rectangular. More preferably, the cross section of the sheet is substantially rectangular with rounded edges.

Preferably, the grip is adapted to be placed on handles, whereby said grips are in direct contact with their users. More preferably, the grip is adapted to be placed around the handle in an overlapping manner. More preferably, said placement is helical.

Preferably, the weakening line is a reduction in the thickness of the sheet in a certain area. More preferably, said reduction is continuous, that is, the entire weakening line has a thickness less than the rest of the sheet.

Preferably, the weakening line comprises a plurality of aligned penetrations. More preferably, said plurality of penetrations completely crosses the thickness of the sheet.

Preferably, said penetrations are circular. Preferably and according to other examples, said penetrations are elongated, meaning, slots. More preferably, the weakening line comprises a combination of circular penetrations and elongated penetrations.

Preferably, the weakening line comprises at least one straight direction. More preferably, the weakening line comprises a plurality of straight sections. More preferably, the straight sections present different directions.

Preferably, a weakening line comprises a first direction that is substantially parallel to the longitudinal axis of the sheet. The longitudinal axis is understood as the axis of the sheet in the direction with a greater dimension.

Preferably, the weakening line comprises a second direction that is substantially perpendicular to the longitudinal axis of the sheet.

Preferably, the sheet comprises at least a first weakening line in a direction substantially parallel to the longitudinal axis of the sheet, and a second weakening line in a direction substantially perpendicular to the longitudinal axis of the sheet. More preferably, a plurality of first weakening lines are spaced approximately between 10 and 50 millimetres apart, thus defining the width of the grip. More preferably, a plurality of second weakening lines are spaced approximately between 500 and 2000 millimetres apart, thus defining the length of the grip tape.

Preferably, each grip tape comprises a conical or trapezoidal base in the direction of the longitudinal axis of the grip tape. More preferably, each grip tape has a base with a chamfer. More preferably, at least one side of a grip is inclined with respect to the longitudinal axis of the grip.

Preferably, one end of each grip comprises a first line of weakening. A first line of oblique weakening comprises at least one direction not parallel or perpendicular to the longitudinal axis of the grip. More preferably, the first line of oblique weakening comprises a weakening line having a direction of an angle of between 3° and 30° with respect to the longitudinal axis of the grip. More preferably, the first weakening line comprises a direction of an angle of between 6° and 20° with respect to the longitudinal axis of the grip. Longitudinal axis should be understood as the axis of the grip in the largest dimension. Therefore, the direction of the longitudinal axis of the grip and the direction of the longitudinal axis of the sheet may not coincide. In some examples, the longitudinal axis of the grip tape and the longitudinal axis of the sheet could be perpendicular. Said first line of oblique weakening serves to remove the disposable area of the grip, and thus facilitate the placement of said grip on the handle.

Preferably, the end of each grip having the first oblique weakening line also has a second oblique weakening line of between 0.1° and 6°. More preferably, the second oblique weakening line comprises a weakening line having a direction with an angle of between 0.3° and 3° with respect to the longitudinal axis of the grip. More preferably, the second weakening line comprises a direction of an angle between 0.6° and 0.9° with respect to the longitudinal axis of the grip tape. The second oblique weakening line may be used to remove a second disposable area from the grip, and thus facilitates the positioning of said grip tape on the handle.

Preferably, the grip has a geometry substantially symmetrical with respect to the longitudinal axis.

Preferably, the sheet formed by the plurality of grip tapes is made by a polymer and/or a type of leather either organic or inorganic. More preferably, said sheet is made by at least one of the following materials: (i) low density polyurethane (PU LD), (ii) other types of polyurethane, (iii) leather, and (iv) any type of leather such as artificial leather. These materials allow the grip tape to provide the necessary friction to achieve a satisfactory grip, and can also absorb liquids such as sweat. Additionally, they are flexible and elastic materials.

Preferably, the thickness of the sheet formed by the plurality of grip tapes is approximately between 0.1 and 4 millimetres. More preferably, the thickness of the sheet is approximately between 0.2 and 2 millimetres

Preferably, the assembly presenting the sheet containing the plurality of grip tapes further comprises a protective film disposed on the outer face of each grip. More preferably, the protective film is made of a polymeric material. More preferably, the protective film is substantially transparent. The purpose of said protective film is to protect the outer face of the grip from external agents, for example from the atmospheric agent, which may damage and/or alter the physical and/or chemical characteristics of said outer face of the tape. It should be borne in mind that the user will contact the handle through the outer face of the grip tape, so maintaining the good conditions and initial characteristics of the outer face of the grip tape is of vital importance.

Preferably, the grips comprise surface irregularities on their outer face. More preferably, surface irregularities are geometric patterns. More preferably, the surface irregularities are orifices. Said orifices may be completely penetrating or not. The purpose of such surface irregularities is to increase the grip between the object and the user, in particular, between the handle of the sports racket and the player.

Preferably, each grip has the same geometry and size, that is, all the grips arranged on the sheet have the same shape and dimensions.

Preferably, each grip has a different size and/or geometry from each other. More preferably, at least one first grip has a different shape and/or dimensions with respect to at least one second grip.

Preferably, each grip tape has a substantially rectangular geometry.

Preferably, each grip has four sides, a first side and a second side being opposite to each other and substantially parallel, and a third side and a fourth side being substantially perpendicular to the first and second side, that is, the grip has a rectangular geometry.

Preferably, each grip has four sides, a first side and a second side being opposite to each other and substantially parallel, a third side substantially perpendicular to the first and second side, and a fourth side that has an oblique direction. According to another preferred embodiment, each grip has five sides, with a first side and a second side opposite to each other and substantially parallel, a third side substantially perpendicular to the first and second side, a fourth side having an oblique direction, and a fifth side arranged between the first side and the fourth side and which is also substantially parallel to the third side. According to another preferred embodiment, each grip has six sides, with a first side and a second side opposite to each other and substantially parallel, a third side substantially perpendicular to the first and second side, a fourth side having an oblique direction, a fifth side arranged between the sixth side and the fourth side, which is also substantially parallel to the third side, and a sixth side arranged between the first side and the fifth side presenting an angle with respect to the first and fifth side between ninety (90°) and one hundred-eighty degrees (180°) with respect to the longitudinal axis of said grip. More preferably, the angle of the sixth side is substantially less than one hundred-eighty degrees (180°). More preferably, the angle of the sixth side is approximately between zero point five degrees (0.5°) and ten degrees (10°).

Preferably, each grip comprises a substantially flat and elongated body. It is understood as substantially flat when the grip is not folded, that is, when it is in the extended position. As explained above, the sheet comprising the plurality of grips is formed by a flexible and elastic material. Therefore, the grips comprised in said sheet are also of the same material, and of course, said grips are flexible and elastic. The skilled person knows that a flat and flexible body is susceptible to be flexed, for example, folded. Therefore, the grip tapes are flat when they are unfolded, but of course, said grips have a non-flat shape when folded.

Preferably, the grip has at least one first adhesive means. More preferably, said first adhesive means is located on the inner face of the grip. More preferably, said first adhesive means is part of the grip itself. More preferably, the first adhesive body is located at one end of the grip, meaning the grip tape has an adhesive surface on one of its ends, and on its inside face. More preferably, one of its ends is the free end. The first adhesive means has the purpose of fixing the inner face of the grip to the outer surface of the handle.

Preferably, the grip has a second adhesive means. More preferably, said second adhesive means is located on the inside face of the grip. More preferably, said second adhesive means forms part of the grip itself. More preferably, the second adhesive body is located at the end of the grip where the first adhesive body is not located. Therefore, the opposite end of the free end of the grip has two adhesive surfaces: a first adhesive surface on one end and on its inner face and a second adhesive surface on the other end on the same inner face. Preferably, the second adhesive surface is located in an intermediate position from the two ends and on the inner face of the grip tape. Therefore, the second adhesive surface may be placed in several positions on the inside face of the grip, as long as it does not overlap with the first adhesive surface.

Preferably, the second adhesive means is an adhesive means independent of any grip, that is, it is an element that is not a part of any grip tape. More preferably, the second adhesive means comprises a sheet. More preferably, said sheet of the second adhesive means has a face comprising an adhesive material. More preferably, said adhesive side of the second adhesive means has a protective film. Said protective film of the second adhesive means is temporarily placed, that is, not permanently on the adhesive side of the second adhesive means, wherein said second adhesive means is designed so that the user can remove the protective film when needing to make use of the second adhesive means to fix the grip on the handle. More preferably, the protective film of the second adhesive means comprises a geometry similar to that of the sheet of the second adhesive means in such a way that the protective film will cover all or a large part of the adhesive face of the second adhesive means. Said protective film has the objective of protecting the face of the second adhesive means before the user uses it. More preferably, the second adhesive means comprises a plurality of adhesive elements joined together by at least one weakening line, in such a way that the weakening line makes it possible to initiate the tearing or separating of an adhesive element through at least one weakening line. More preferably, the second adhesive means is capable of being folded and unfolded. More preferably, the folding of the second adhesive means is in the form of a roll. Preferably, the folding of the second adhesive means is in the form of an accordion. More preferably, the second adhesive means is arranged approximately equidistantly with respect to the sheet containing the plurality of grips. More preferably, the second adhesive means is arranged in an interlayered manner with the sheet containing the plurality of grips. The term “interlayer” should be interpreted as interposing or placing an element (e.g. the second adhesive means) between two or more parts (e.g. the sheet comprising the plurality of grips). More preferably, the second adhesive means comprises the same number of adhesive elements as the number of grips comprised in the grip assembly.

Preferably, all weakening lines leave a plurality of protrusions or projections in the grip once said grip is separated or teared from the rest of the grip assembly. Said projections are located on the sides where the connection points or connecting bridges of the grip tape were located before the weakening line was broken. The object of said plurality of projections is to increase the desired grip of the grip tape.

Thus, the user will experiment an improvement in the grip of the handle due, in part, to said plurality of projections.

Preferably, the sheet formed by the plurality of grips further comprises a cylinder on which said sheet is rolled.

### BRIEF DESCRIPTION OF THE DRAWINGS

Non-limiting examples of the present disclosure will be described in the following, with reference to the appended drawings.

FIG. 1 is a tennis racket.

FIGS. 2A and 2B show a top view of an assembly formed by two grip tapes arranged in series.

FIGS. 3A and 3B show a plan view of an assembly formed by three grip strips arranged in parallel.

FIG. 4A is a top view of a grip tape assembly arranged in the form of a matrix, that is, arranged in series and in parallel.

FIG. 4B is a top view of a grip tape assembly arranged in the form of a matrix, that is, arranged in series and in parallel, in which each grip tape has two oblique weakening lines.

FIG. 5 is a top view of the geometry of an example of a grip tape.

FIG. 6 is a perspective view of a folded grip tape assembly in the form of a roll.

FIGS. 7A and 7B show a perspective view of a grip tape assembly folded in accordion form.

FIG. 8 is a grip tape having a plurality of protrusions on the side of the grip tape once separated from the rest of the assembly, including, in particular, a detailed view of the post-tear weakening line.

### DETAILED DESCRIPTION OF THE DRAWINGS

The novelty of all the examples described hereinafter are related to weakening lines arranged on a sheet comprising a plurality of grip tapes.

Throughout the present disclosure the word “grip assembly” may be referred to “grip tape assembly”. Similarly, the word “grip” may be referred to “grip tape” or “overgrip”. The weakening lines 14′, 140′, 1400′, 12′, 120′, 1200′, 24′, 240′, 2400′, 13′, 130′, 1300′ comprise perforations. According to one example, the perforations pass through the entire thickness of the sheet 2. According to another example, said perforations do not pass through the entire thickness of the sheet 2, meaning, said perforations are not fully penetrable. According to another example, the weakening lines 14′, 140′, 1400′, 12′, 120′, 1200′, 24′, 240′, 2400′, 13′, 130′, 1300′ are a single, non-penetrable, elongated and continuous line shaped perforation that do not pass through the entire thickness of the sheet 2, meaning, the depth of said elongated perforation is less than the thickness of the sheet 2. In other words, the weakening lines 14′, 140′, 1400′, 12′, 120′, 1200′, 24′, 240′, 2400′, 13′, 130′, 1300′ have a reduced thickness with respect to the rest of the sheet 2. According to another example, weakening lines 12′, 120′ and 1200′ may be obtained by bending the sheet 2 at least once. It is well known to a skilled person that the maximum breaking stress of a line may be reduced by bending the sheet containing said line.

According to another example, a weakening line 14′, 140′, 1400′, 12′, 120′, 1200′, 24′, 240′, 2400′, 13′, 130′, 1300′ comprises a plurality of aligned perforations. These penetrations may be circular or may have an elongated geometry such as slots. According to one example, a weakening line may comprise a combination of circular penetrations and elongated penetrations. According to another embodiment, a weakening line has a single elongated penetration.

In addition, a weakening line 14′, 140′, 1400′, 12′, 120′, 1200′, 24′, 240′, 2400′, 13′, 130′, 1300′ may have different shapes and/or draw different trajectories. According to an example, a weakening line 14′, 140′, 1400′, 12′, 120′, 1200′, 24′, 240′, 2400′, 13′, 130′, 1300′ may include several sections and at least one of them is a straight path.

In other words, a weakening line 14′, 140′, 1400′, 12′, 120′, 1200′, 24′, 240′, 2400′, 13′, 130′, 1300′ provisionally connects two or more grip tapes with the rest of the sheet 2, until an external force on at least one of the grip tapes is applied such that said force exceeds the maximum breaking stress of the connecting points of the weakening line.

In addition, once weakening lines 4′, 140′, 1400′, 12′, 120′, 1200′, 24′, 240′, 2400′, 13′, 130′, 1300′ are separated or torn, the grip tapes that have been separated are left with a plurality of protrusions or projections on their sides (e.g. edges). These protrusions are located on the sides (e.g. edges) where the connection points or connection bridges of the grip tape were located. The purpose of said plurality of projections is to increase the desired grip between the grip tape, once placed on the handle, and the user. Thus, the user may experience an improvement in the grip of the handle due, in part, to said plurality of projections.

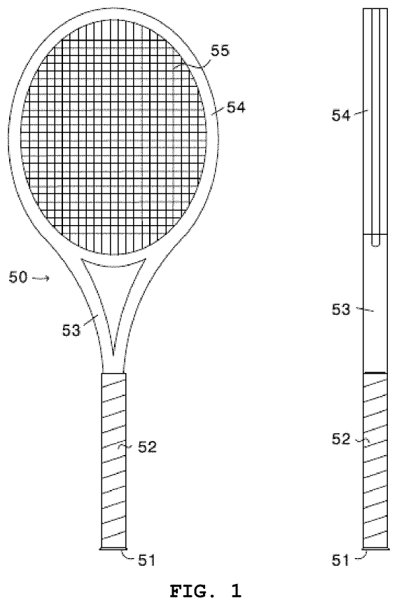

FIG. 1 shows a tennis racket 50 comprising: a butt cap 51, a handle 52, a throat 53, a beam 54, and the strings 55. The grip tapes assembly 1 of the present invention is adapted to be partially unfolded in the case the assembly 1 was folded; separate a first grip tape 10 by breaking the weakening lines, and place the separated grip tape 10 on the handle of the tennis racket 50. However, the use of at least one grip tape 10 comprised in the assembly 1 is not limited only to tennis racket handles 52, but to a wide variety of handles, such as: badminton rackets, squash rackets, paddle rackets, as well as to any other type of rackets (not shown). In addition, the grip tape 10 may also be placed on bicycle handlebars, motorcycle handlebars or any other type of handle, such as, for example, fishing rods (not shown).

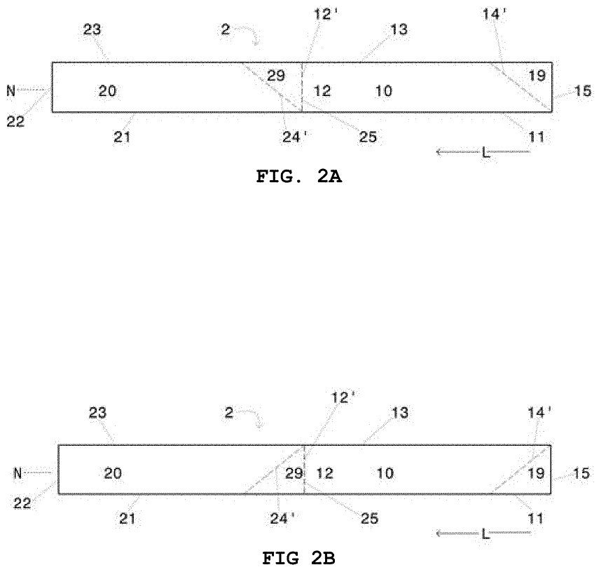

FIGS. 2A, 2B, 3A, 3B, 4A, 4B, 6, 7 show the grip tapes assembly 1, wherein said grip tapes 10, 100, 1000, 20, 200, 2000 are part of the sheet 2 that is made of an elastic and flexible material. Sheet 2 has an approximate thickness of between 0.1 millimetres and 4 millimetres. In particular, sheet 2 has an approximate thickness of between 0.2 millimetres and 2 millimetres. According to an example, the material of sheet 2 is made of a low density polyurethane (PU LD). According to other examples, the sheet 2 is made of any type of polyurethane. According to other examples, sheet 2 is made of leather. According to other examples, sheet 2 comprises at least some of the following materials: polyurethane or leather. These materials allow the flat sheet to be bent and/or curved. This is important because in several examples, the grip assembly 1 is of a considerable length; it can exceed fifty meters in length. Therefore, it is important to use a material that allows the assembly 1 to be folded.

FIGS. 2A and 2B show an example of the assembly 1 including a first grip tape 10 and a second grip tape 20, wherein said second grip strip 20 is located behind the first grip tape 20 where both grip tapes 10 and 20 are attached to one another by a weakening line 12′, in particular, through breakable or tear-off links 12′. The term “behind” should be understood as the second grip tape 20 is arranged next to the first grip tape 10 with respect to the longitudinal axis (L) of the first grip tape 10, in the adjacent position. Throughout the present disclosure, said arrangement of grip tapes 10, 20 . . . N will be referred to as a series arrangement. An oblique weakening line 14′ is optionally provided approximately near to the first end 15 of the first grip tape 10, while the second end 12 of the first grip tape 10 is attached to the first end 25 of the second grip tape 20 through the weakening line 12′. FIGS. 2A and 2B show an example of a grip tape assembly 1 having only two grip tapes 10 and 20. However, in other examples (not shown), the grip tape assembly 1 may include a plurality (N) of grip tapes 10, 20, . . . N, arranged one next to the other with respect to the longitudinal axis (L) of the first grip tape 10.

In FIGS. 2A and 2B, the weakening line 12′ is arranged in such a way as to allow the tearing or the separating from the first grip tape 10 through said weakening line 12′.

Thus, weakening lines 12′ are points of attachment and separation between different grip tapes 10 and 20, so that the application of a force on the grip tape 10 will not be transmitted on a direct line through the rest of the grip tapes 20, but will be deviated by the spaces opposite the points of attachment 12′ of the pulled grip tape 10, thus producing a transverse load sufficient to break them, e.g. to break the weakening line 12′.

According to an example corresponding to FIGS. 2A and 2B, the grip tapes 10 and 20 are arranged in series, and are joined through the weakening line 12′ comprising a straight section located from the side 11 to the opposite side 13 of the first grip tape 10, allowing the first grip tape 10 to be separated from the second grip tape 20. Meaning, the weakening line 12′ allows the separation of the first grip tape 10 from the rest of the assembly 1 when the force applied exceeds the maximum allowable force of the weakening line 12′. Therefore, the weakening line 12′ has the same length as the width of the grip tape 10. Arrangement in series should be understood as a pattern of grip tapes, in which a second end 12 of the first tape 10 is attached to the first end 25 of the second grip tape 20 in the direction of the longitudinal axis (L) of the first grip tape 10. In addition, there is optionally a second weakening line 14′ and a third weakening line 24′, in which both weakening lines are arranged in an oblique position, meaning, an oblique orientation 14′ and 24′ isolating the so-called disposable zone 19 and 29 of their respective grip tapes 10 and 20. When the oblique weakening line 14′ is torn, the disposable area 19 will be separated from the rest of the first grip tape 10. Thus, a free end of the first grip tape 10 with an oblique geometry is obtained that helps users to correctly place said first grip tape 10 on the handle 52. Similarly, when the oblique weakening line 24′ is torn, the disposable area 29 will be separated from the rest of the second grip tape 20. Thus, a free end of the second grip tape 20 is achieved with an oblique geometry that helps users to correctly place said second grip tape 20 on the handle 52.

For example, one way to place a grip tape 10 on the handle is to place the end of the grip tape 10 having the oblique side 14 at the lower end of the handle of the racket and to place the grip tape 10 around said handle 52 in helical position.

According to an example corresponding to FIG. 2A, each oblique weakening line 14′ and 24′ starts in an area proximate or coincident with the vertex of the lower side 11 and 21 and of the first end 15 and 25. According to other examples said oblique cuts 14′ and 24′ start in an area proximate or coincident with the vertex of the lower side 11, and 21 and of the second end 12 and 22. According to another example of FIG. 2B, said oblique weakening lines 14′, 24′ start in an area proximate or coincident with the vertex of the upper side 13 and 23 and of the first end 15 and 25. According to other examples, said oblique cuts 14′ and 24′ start in an area proximate or coincident with the vertex of the upper side 13 and 23 and of the second end 12 and 22. The term “start” refers to the location of one end of the oblique weakening line 14′ and 24′, which extends obliquely to the opposite side.

According to an example (not shown), the grip tapes 10, 20, . . . N do not include the disposable zones 19 and 29.

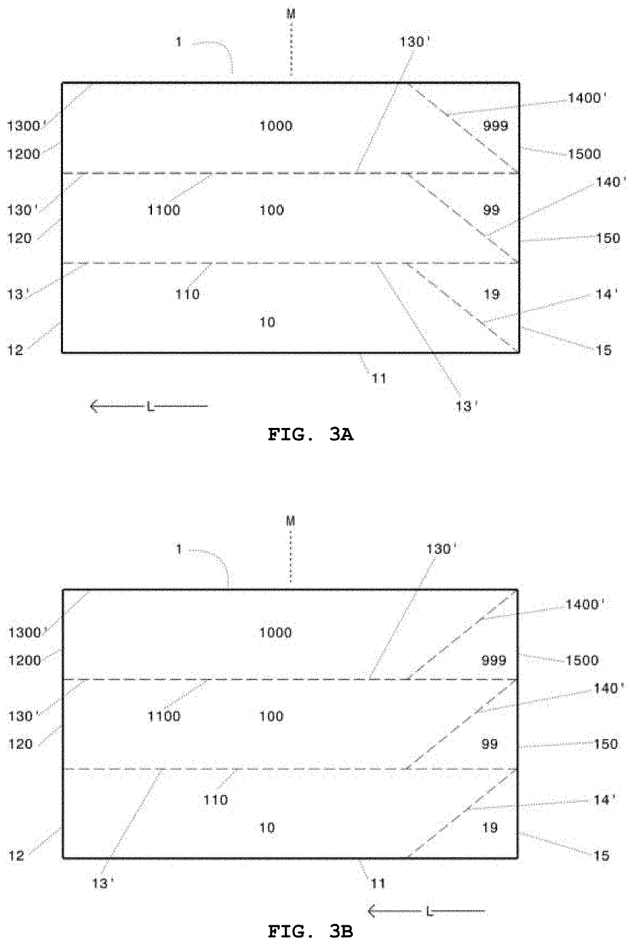

FIGS. 3A and 3B show an example of a grip tapes assembly 1 having, in particular, three grip tapes: a first grip tape 10, a second grip tape 100 and a third grip tape 1000. In this example, the second grip tape 100 is arranged next to the first grip tape 10, such that the attachment of both grip tapes 10 and 100 is achieved through a weakening line 13′, in particular, breakable or tear-off links 13′. The term “next to” should be understood as that the second grip tape 100 is arranged in an adjacent position to the first grip tape 10 with respect to the perpendicular direction of the longitudinal axis (L) of the first grip tape 10. Throughout the present disclosure, said arrangement of grip tapes 10, 100, 1000 . . . M will be called parallel arrangement. The parallel arrangement is to be understood as a pattern of grip tapes continuously distributed along a direction perpendicular to the longitudinal axis (L) of the first grip tape 10 according to examples corresponding to FIGS. 3A and 3B. FIGS. 3A and 3B are an example of a grip tapes assembly 1 having only three grip tapes 10, 100, and 1000 in parallel connection. However, in other examples (not shown), the grip tapes assembly 1 has a plurality (M) of grip tapes 10, 100, 1000 . . . M, arranged adjacently to each other with respect to the perpendicular direction of the longitudinal axis (L) of the first grip tape 10.

According to an example corresponding to FIGS. 3A and 3B, the grip tapes 10, 100, 1000 . . . M are arranged in parallel, joined by two weakening lines 13′ and 130′. In particular, the first weakening line 13′ joins the first grip tape 10 with the second grip tape 100. In the same way, the second weakening line 130′ joins the second grip tape 100 with the third grip tape 1000. As with the examples corresponding to FIGS. 2A and 2B, all the grip tapes may optionally have other weakening lines 14′, 140′, 1400′ in an oblique direction located in an area close to the first end 15, 150 and 1500 of each grip tape 10, 100 and 1000. According to an example corresponding to FIG. 3A, each oblique weakening line 14′, 140′, 1400′ starts in an area proximate or coincident with the corner of the lower side 11, 110 and 1100 and of the free end 15, 150 and 1500 also called the first end. According to other examples, said oblique weakening lines 14′, 140′, 1400′ start in an area proximate or coincident with the corner of the lower side 11, 110 and 1100 and of the second end 12, 120 and 1200 (not shown). According to other examples corresponding to FIG. 3B, said oblique weakening lines 14′, 140′, 1400′ start in an area proximate or coincident with the corner of the upper side 13, 130 and 1300 and of the free end 15, 150 and 1500 also called first end. According to other example, said oblique weakening lines 14′, 140′, 1400′ start in an area proximate or coincident with the corner of the upper side 13, 130 and 1300 and of the second end 12, 120 and 1200 (not shown).

According to an example in which the grip tapes are arranged in parallel, the grip tapes 10, 100, 1000 . . . M do not include the disposable areas 19, 99 and 999 (not shown).

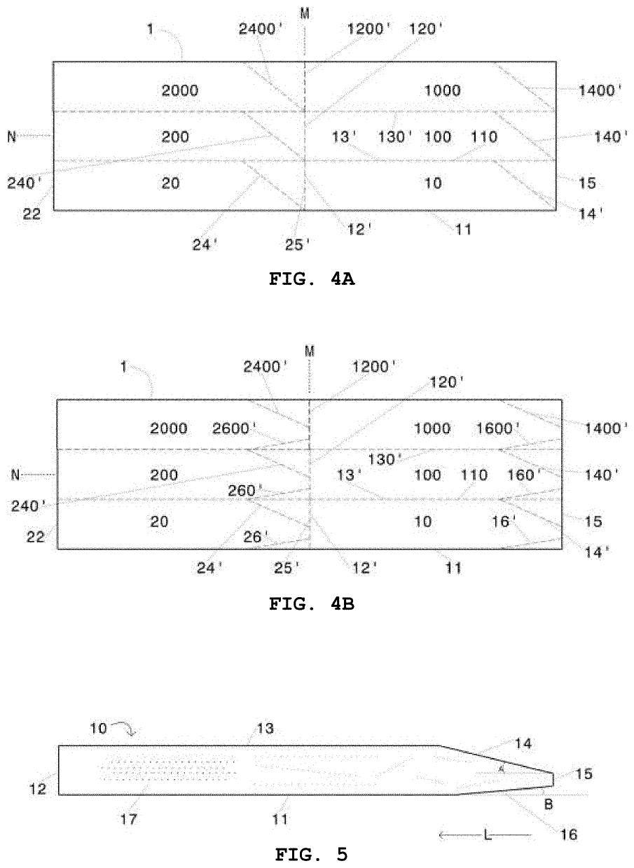

FIG. 4A is an example of a sheet 2 having a plurality of grip tapes arranged in the form of a matrix. As can be seen in FIG. 4, the first grip tape 10 is joined through the weakening line 12′ with the grip tape 20, whereas the first grip tape 10 is attached through the weakening line 13′ with the grip tape 100. Therefore, the arrangement of grip tapes 10, 20, . . . N and 10, 100, 1000 . . . M in the matrix form of FIG. 4 is a combination of the serial arrangement shown in FIG. 2A and of the parallel arrangement shown in FIG. 3A.

According to another example (not shown), the grip tapes 10, 20, . . . N may have a different width than the grip tapes 100, 200, . . . N. For example, the grip tapes 10, 20, . . . , N may have a distance of ten millimetres between the side 11 and its opposite side 13, while the grip tape 100, 200, . . . N may have a distance between the side 110 and its opposite side 130 of fifty millimetres.

According to another example (not shown), the grip tapes 10, 100, 1000 . . . M may have a different length than the grip tape 20, 200, 2000 . . . M. For example, the grip tapes 10, 100 , 1000 . . . M may have a distance of five hundred millimetres between the side 12 and the side 15, while the grip tapes 20, 200, 2000 . . . M may have a distance between the side 22 and the side 25 of two thousand millimetres.

According to another example, the total length of the first row of grip tapes 10, 20, . . . N, may be approximately equal to the total length of the second row of grip tapes 100, 200, . . . N. Namely, the partial sum of the length of each of the grip tapes 10, 20, . . . N is similar to the partial sum of the length of each of the grip tapes 100, 200, . . . N. According to an example (not shown), the grip tapes 10, 20, . . . N and 10, 100, . . . M may have different colours according to their features such as geometry. For example, all the grip tapes 10, 20, . . . N and 10, 100, . . . M that may have the same colour, means that they have the same length, or the same width, or the same oblique cutting angle A, etc. For example, if a grip tape 10 is blue, it means that it has a length of two thousand millimetres. If another grip tape 20 is green it means that it has a length of one thousand millimetres. Thus, grip tapes 10, 20, . . . N and 10, 100, M may be classified and/or distinguished quickly due to their visual impact, e.g., colour.

FIG. 4B shows a top view of a grip tapes assembly 1 arranged in the form of a matrix, meaning, arranged in series and in parallel, in which each grip tape has two oblique weakening lines. For example, the grip tape 10 may have a first weakening line 14′ and a second weakening line 16′. Thus, the grip tape 100 has the weakening line 140′ and the weakening line 160′. In addition, the grip tape 1000 may have the weakening line 1400′ and the weakening line 1600′. Similarly, the grip tape 20 may have the weakening line 24′ and the weakening line 26′. And, the grip tape 200 has the weakening line 240′ and the weakening line 260′. In addition, the grip tape 2000 may have the weakening line 2400′ and the weakening line 2600′.

FIG. 5 is the outer face of a grip tape including its surface imperfections 17. In particular, said surface imperfections 17 are recesses 17 that facilitate the sweat from the hands to dry faster and therefore providing a greater desired grip. The recesses 17 may have different shapes, but according to the example shown in FIG. 5, said recesses 17 may have a substantially circular shape and an approximate diameter of one millimetre. In this particular example, said recesses 17 are fully perforating, meaning, they pass entirely through the grip tape 10. Alternatively, recesses 17 may not pass entirely through the grip tape. Of course, other shapes and sizes are not excluded.

According to FIG. 5, each grip tape has six sides, with a first side 11 and a second side 13 opposite one another and substantially parallel, a third side 12 substantially perpendicular to the first 11 and the second side 13, a fourth side 14 in an oblique direction with a certain inclination A, a fifth side 15 arranged between the sixth side 16 and the fourth side 14, wherein said fifth side 15 is substantially parallel to the third side 12, and a sixth side 16 arranged between the first side 11 and the fifth side 15 having an opening angle A with respect to the longitudinal axis (L) between three and thirty degrees. In particular, the angle A is twenty degrees. According to another example, the opening angle B is substantially greater than zero degrees. More particularly, the inclination angle of B is between 0.5° and 10°.

According to FIG. 5, the sides 11 and 13 are spaced approximately between ten and fifty millimetres apart, thus defining the width of the grip tape 10. In addition, the sides 12 and 15 are spaced approximately between five hundred and two thousand millimetres apart, thus defining the length of the grip tape 10.

In addition, the assembly 1 may include a protective film arranged on the outer face of the grip tape 10, which is the face or surface that is in contact with the user. The protective film has the purpose of protecting the outer face of the grip tape 10 against external agents, such as, atmospheric agents (before being fixed on the handle). In particular, said film has an adhesive layer on one of its faces that adheres to the outer face of the grip tape 10. According to an example (not shown), the film is made of transparent plastic. In another example (not shown), the plastic protective film may include a weakening line. In particular, the protective film may include at least one weakening line substantially coincident with at least one weakening line of sheet 2. More particularly, all the weakening lines of the protective film are substantially coincident with all the weakening lines of sheet 2. Therefore, when the user applies a force to a grip tape 10 higher than the breaking stress of the weakening line 12′ that joins the grip tape with the rest of the sheet 2 along with the breaking strength of the weakening line of the protective film, said grip tape with its protective film on its outer face will be separated from the rest of the assembly. Therefore, the separating or tearing of the grip tape 10 also involves the separating of the corresponding protective film with respect to the rest of the protective film. The protective film must be removed, e.g. detached from the outer face of the grip tape 10 before placing said grip tape 10 on the handle 52. In other examples (not shown), the protective film does not exhibit any weakening line.

Said protective film is adhered to the outer face of the grip tapes 10, 20, . . . N and 10, 100, 1000, . . . M provisionally. If the grip tape 10 is folded, for example in the form of a roll 666, the protective film will also be folded accordingly. When the user unfolds the grip tape 10, he will also be unfolding its protective film.

Therefore, the functional surface is the outer face of the grip tape, which is in contact with the user's hand once the grip tape has been placed. Therefore, said outer face provides the grip directly to the user. However, the inside face also has a function, since it is in contact with the handle 52 of the racket, and it also has to meet several technical requirements to ensure the grip tape does not move once it has been placed on the handle.

According to an example (not shown), the assembly 1 may include a second protective film arranged on the inside face of the grip tape 10.

According to an example (not shown), each grip tape 10, 100, 1000, 20, 200, 2000 may include a first adhesive body on its inner face in order to fix the inner face of the grip tape 10 to the outer surface of the handle 52. In particular, said first adhesive body is located at the end 14 of the grip tape 10.

According to another example (not shown), each grip tape 10, 100, 1000, 20, 200, 2000 may include a second adhesive body on its inner face. Thus, said second adhesive body is part of the grip tape 10, 100, 1000, 20, 200, 2000. In particular, the second adhesive body is located at the end 12. Therefore, the grip tapes 10, 100, 1000, 20, 200, 2000 may have two adhesive surfaces: a first adhesive surface at one end 14 and on its inner face and a second adhesive surface at the other end 12 on the same inner face. According to other examples (not shown), the second adhesive surface is located in an intermediate position between the two ends 12 and 15 and on the inner face. Therefore, the second adhesive surface may be placed in several positions on the inner face of the grip tape 10, as long as it does not overlap with the first adhesive body.

According to another embodiment example (not shown), the second adhesive body is a different adhesive body from the sheet 2, that is, the second adhesive body is an element that is not part of any grip tape 10. In particular, the second adhesive body may include a sheet. More particularly, said sheet of the second adhesive body has a face comprising an adhesive means. More particularly, said adhesive face of the second adhesive body may have a protective film. Said protective film of the second adhesive body is temporarily placed temporarily on the adhesive side of the second adhesive body, wherein said second adhesive body is adapted so that the user can remove the protective film when requiring the use of the second adhesive body to fix the grip tape 10 on the handle 52. According to one example, the protective film of the second adhesive body may have a geometry similar to the geometry of the sheet of the second adhesive body, in such a way that the protective film will cover the entire or a large part of the adhesive face of the second adhesive body. Said protective film has the purpose of protecting the adhesive face of the second adhesive body before the user uses it. More particularly, the second adhesive body may include a plurality of adhesive elements joined together by at least one weakening line, in such a way that the weakening line makes it possible to start the tearing or separating of an adhesive element through at least one weakening line. According to another embodiment, the second adhesive body may be folded and unfolded. More particularly, the folding of the second adhesive body is in the form of a roll. In particular, the folding of the second adhesive body is in the form of an accordion. In particular, the second adhesive body is arranged approximately equidistantly with respect to the sheet 2 containing the plurality of grip tapes 10, 100, 1000, 20, 200, 2000. In particular, the second adhesive body is arranged in an interlaying manner with the sheet 2 containing the plurality of grip tapes. The term “interlaying” should be interpreted as interposing or placing an element (e.g. the second adhesive body) between two or more parts (e.g. the sheet 2 having the plurality of grip tapes). According to an example, the second adhesive body may include the same number of adhesive elements as grip tapes arranged on the sheet 2.

According to an example, a first element of the second adhesive body is located in an area near to the first grip tape 10. Thus, the user partially unfolds the assembly 1 finding the first grip tape 10 in proximity to the first tape element of second adhesive body. According to one example, this facilitates the separation of the grip tape 10 from the sheet 2 through a weakening line 12′ and the first adhesive element of the second adhesive body through another weakening line (not shown) without the need to unfold the entire assembly 1.

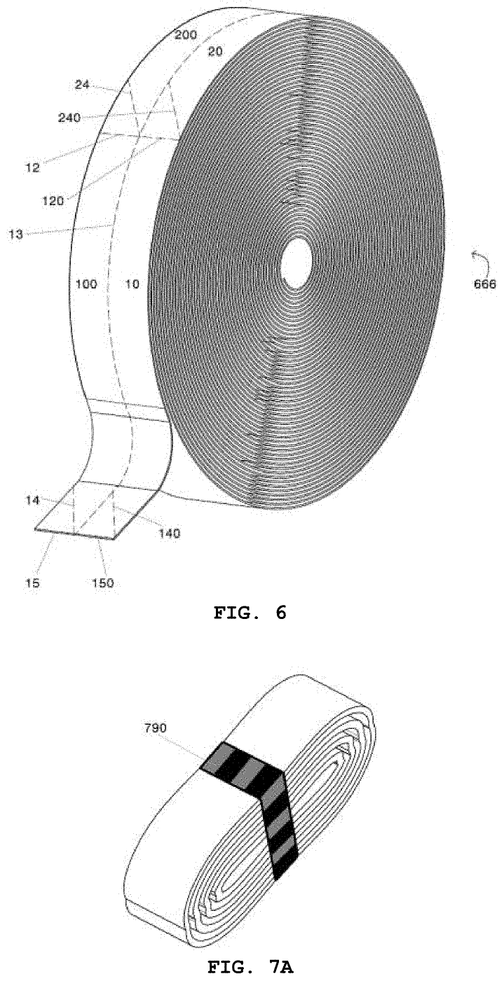

FIG. 6 is a grip tapes assembly 1 according to a first folding embodiment, wherein said grip tapes assembly 1 is folded in the form of roll form 666.

FIG. 6 is a rolled grip tape assembly 1, wherein if a grip tape of the assembly 1 is pulled, a plurality of grip tapes may be unrolled (e.g. unwound) unless the free movement of the roll 666 is prevented by friction or other means. In the event that said movement of the roll 666 is prevented and a force is still applied to the first grip tape 10, the stress in the weakening line 12′ will increase until it exceeds the maximum breaking stress, at which instant the user will separate the first grip tape 10 from the rest of the roll 666.

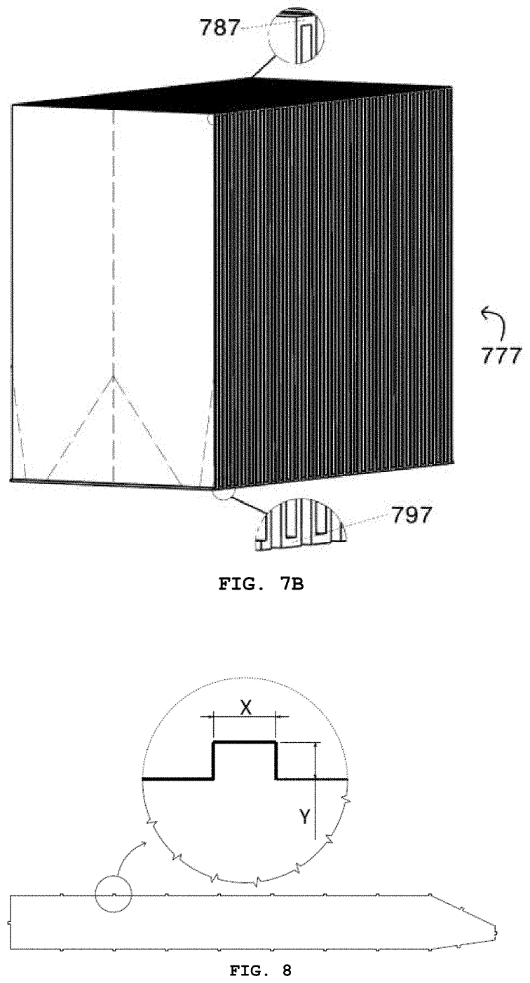

FIGS. 7A and 7B show a grip tapes assembly 1 according to a second folding embodiment, wherein said grip tapes assembly 1 is folded in the form of an accordion 777. That is, assembly 1 is folded in the shape of an eight or a zigzag 777, in such a way that it may include two more parallel folds 787 and 797 made in opposite directions alternatively. The accordion fold 777 is a straight unidirectional fold presenting an iteration of the unitary fold, meaning, the fold that crosses in a straight line to a sheet. Of course a modification may be possible to make the fold 777 more rigid, or changes in the direction within the same sheet 2 allowing for different arrangements on symmetry. In addition, the folding angles may also be varied to obtain other shapes. For example, the elasticity of assembly 1 allows warps that produce changes in direction. The accordion fold 777 may come to close on itself producing a semi-open shape, or closed forms, for example, through a tape 790 that wraps around the grip tapes assembly 1.

FIG. 8 is a detailed view of a post-tear weakening line, meaning, once the breakable links of said grip tape have been broken. The residual length X is approximately between 0.01 millimetres and 5 millimetres. The residual height Y is approximately between 0.001 millimetres and 2 millimetres. Said protrusions or residual elements are of vital importance to increase the grip of the grip tape.

According to another embodiment (not shown), the assembly 1 may also comprise a cylinder on which it is rolled.

In short, an assembly 1 may comprise a sheet 2 of grip tapes arranged in series 10, 20, . . . N, or in parallel 10, 100, 1000 . . . M, or in both manners, meaning, a combination in the form of a matrix separated by weakening lines 12′ , 120′, 1200′, 13′, 130′ and 1300′. Optionally, said grip tapes 10, 20, . . . N, 100, 1000 . . . M may have oblique weakening lines 14′, 140′, 1400′, 24′, 240′, 2400′ that allow the removal of the disposable areas 19, 29, 99, 999. Furthermore, each grip tape may optionally include surface imperfections 17 such as recesses 17. The grip tapes 10, 20, . . . N, 10, 100, 1000 . . . M may have the same geometry and size, although in other examples, each grip tape 10, 20, . . . N, 10, 100, 1000 . . . M may have a geometry and a size different from each other. Additionally, the inner face of the first end 14 or 15 of each grip tape 10, 20, . . . N, 10, 100, 1000 . . . M may comprise a first adhesive body for facilitating the placement and fixing of said first end 14 or 15 on the outside surface of the handle. Optionally, assembly 1 may also include a protective film on the outside of each grip tape 10, 20, . . . N, 10, 100, 1000 . . . M. Additionally, the assembly 1 may further comprise a second adhesive body. Said second adhesive body may be an adhesive area located on the inner face of each grip tape, or according to other embodiments, said second adhesive body may be a sheet different from the sheet 2 of grip tapes. Said sheet of the second adhesive body may include an adhesive face. In addition, the second adhesive body may include a plurality of adhesive elements partially joined together through weakening lines.

There are several methods for manufacturing the above-mentioned grip tapes assembly 1.

According to a first example of the manufacturing process, a device places a sheet 2 on a first level and a protective film on a second level, in such a way that the lower face of the protective film is placed substantially parallel to the upper face of the sheet 2 containing the grip tapes. Subsequently, a movement of the sheet 2 and the protective film is initiated, which is considered a forward movement, meaning, they advance substantially in the same direction and speed, separately. Then, the sheet 2 and the protective film come closer together as they advance. In a certain instant in time, the inner face of the protective film comes into contact with the outer face of said sheet 2. According to an example, the inner face of the protective film may include an adhesive or an adhesive body. According to another example, the device places a type of adhesive, for example glue, between said inner face of the protective film and the outer face of the sheet. Then, the protective film is adhered to the sheet 2 as they both advance. Next, a punching operation is performed, meaning, the manufacturing device makes penetrations to the assembly 1 formed by the sheet 2 and the protective film. Said aligned penetrations in one or more sections are the weakening lines 14′, 140′, 1400′, 12′, 120′, 1200′, 24′, 240′, 2400′, 13′, 130′, 1300′. Thus, weakening lines 14′, 140′, 1400′, 12′, 120′, 1200′, 24′, 240′, 2400′, 13′, 130′, 1300′ are produced by die cutting (e.g. punching). Finally, assembly 1 is folded. According to an example, the fold may be in the form of roll 666, while according to another example the folding may be done in the form of accordion 777. Other types of folding are, of course, possible and not excluded.

According to a second example of the manufacturing process, an operator, or alternatively an apparatus, places a protective film on top of the sheet 2. According to an example, said placement occurs approximately at the same time at all points of the protective film 2, meaning, the protective film and sheet 2 approach until they contact each other. According to an example, the approach is carried out in a position and/or movement that is substantially parallel. The placement of the film and the sheet 2 may not occur at about the same time: first a part is afixed and the rest is progressively afixed. Both the protective film and the sheet 2 may have a similar size and geometry, and not necessarily in the form of an elongated strip or an elongated sheet. Said sheet may have several geometries such as a square or a rectangle. Other geometries, of course, are possible. Due to the effect of the adhesive, either on the inner face of the protective film or on a built-in adhesive, for example an adhesive, between the protective film and the sheet 2, it is possible to join them (e.g., to glue them). Next, a device cuts and die-cuts the sheet 2 and the protective film at the same time, caused by a relative movement between said assembly 1 and the apparatus that performs the cutting and the die-cutting. According to another example, the apparatus cuts and die-cuts the sheet 2 and the protective film at different times. For example, first cuts and then die-cuts. Or for example, first the cutting operation is started and at some later time the die-cutting operation is started, regardless of whether the cut has finished or not. Or for example, the device first die-cuts and then cuts. Or first the die-cutting operation is started and at some later moment the cutting operation is started, regardless of whether the die-cutting has finished or not. Finally, the assembly is folded. According to an example, the folding may be in the form of roll 666, while according to another example, folding may be done in the form of accordion 777. Other types of folding are, of course, possible and not excluded.

Although only a number of examples of said grip tape assembly has been disclosed herein, other alternatives, modifications, uses and/or equivalents thereof are possible. Furthermore, all possible combinations of the described examples are also covered. Thus, the scope of the present disclosure should not be limited by particular examples but should be determined only by a fair reading of the claims that follow.

1- A grip assembly comprising a sheet comprising a plurality of grips for handles, said plurality of grips being contained in the sheet itself, such that at least one grip is adapted to be separated from the sheet through at least one weakening line when said sheet receives a force greater than the breaking stress of said weakening line.

2- The grip assembly according to claim 1, wherein the grips are attached together by at least one weakening line.

3- The grip assembly according to any of the preceding claims, wherein the weakening line comprises a reduction in the thickness of the sheet.

4- The grip assembly according to any of the preceding claims, wherein the weakening line comprises a plurality of aligned penetrations.

5- The grip assembly according to any of the preceding claims, wherein a weakening line comprises a first direction that is substantially parallel to the longitudinal axis of the sheet.

6- The grip assembly according to any of the preceding claims, wherein a weakening line comprises a second direction that is substantially perpendicular to the longitudinal axis of the sheet.

7- The grip assembly according to any of the preceding claims, wherein a plurality of weakening lines comprising the first direction are spaced between approximately 10 and 50 millimeters apart, and by which a plurality of weakening lines comprising the second direction are spaced between approximately 500 and 2000 millimeters apart.

8- The grip assembly according to any of the preceding claims, wherein one end of the at least one grip comprises a first oblique weakening line of between 3° and 20° with respect to the longitudinal axis of the grip tape.

9- The grip assembly according to any of the preceding claims, wherein it also comprises a protective film arranged on an outer face of at least one grip.

10- The grip assembly according to any of the preceding claims, wherein the grip assembly is adapted to be folded and unfolded without substantially altering its physical characteristics.

11- The grip according to any of the preceding claims, wherein the folding comprises a roll-shaped fold, wherein said grip assembly is rolled up on itself at least twice, or alternatively the folding comprises a folding in the form of an accordion.

12- The grip assembly according to any of the preceding claims, wherein it comprises a first adhesive means arranged on an inner face of at least one grip.

13- The grip assembly according to any of the preceding claims, wherein it also comprises a second adhesive means located substantially equidistant to the sheet comprising the plurality of grip tapes.

14- The grip assembly according to any of the preceding claims, wherein the second adhesive means comprises a sheet, said sheet being different from the sheet comprising the plurality of grips, wherein said sheet of the second adhesive means comprises a plurality of adhesive elements joined together by at least one weakening line, such that at least one weakening line makes it possible to separate at least one adhesive element through at least said weakening line, said weakening line being different from the weakening line of the sheet comprising the plurality of grips, said second adhesive means being adapted to folding and unfolding without substantially altering its physical properties.

15- The grip assembly according to any of the preceding claims, wherein the sheet formed by the plurality of grips has a thickness between approximately 0.1 and 4 millimeters, and is also made by at least one of the following materials: (i) low density polyurethane (PU LD), (ii) other types of polyurethane, (iii) leather, and (iv) other types of leather.
